(19) United States
(12) Patent Application Publication
(10) Pub. No.: US 2010/0251332 A1
(43) Pub. Date: Sep. 30, 2010

(54) METHOD AND APPARATUS FOR ESTABLISHING SESSION CONNECTION FOR PREPAYMENT USER

(76) Inventor: Aihao Yin, Shanghai (CN)

Correspondence Address: HARNESS, DICKEY & PIERCE, P.L.C., P.O. BOX 8910, RESTON, VA, 20195, US

(21) Appl. No.: 12/733,943

(22) PCT Filed: Oct. 22, 2008
(86) PCT No.: PCT/CN2008/001779

§ 371 Date: Mar. 30, 2010

(30) Foreign Application Priority Data
Oct. 24, 2007 (CN) 200710181693.9

(51) Int. Cl. G06F 15/16; G06F 21/00

(52) U.S. Cl. 726/3; 709/228

(57) ABSTRACT

Methods and Apparatus for implementing a prepayment service in a NGN environment are provided. At a terminal, authentication information of a user is collected at one time and stored locally, such that all the required authentication information can be extracted from a local storage device. Accordingly, at an application server, all the authentication information can be received in a single message, without need for several interactions. As such, the authentication process required for the prepayment service can be perform in one interaction, which greatly facilitates user operation, and provides improved system efficiency and reduced cost.

### FIELD OF THE INVENTION

The present invention relates to communication network, and more particularly, to methods and apparatus for establishing a session connection for a prepayment user in a communication network, especially in a Next Generation Network (NGN).

### BACKGROUND OF THE INVENTION

Nowadays, the NGN network and its applications, such as VoIP and IMS, are employed by an increasing number of manufacturers in the field of communication. There are also more and more services and applications based on IP networks. In an IP network, SIP protocol is a common call control protocol which can be supported by most terminals or servers to establish call (including voice, video and data) connections and to create more services.

While various services have been provided by utilizing specific advantages of the NGN network, for a smooth evolution, there are still a lot of conventional services in the NGN network, such as a prepayment service, especially the service of prepaid phone card. Generally, a user is required to buy a prepaid phone card with a card number and a password recorded thereon. In a process of calling, the user first dials an access code (e.g., an access code of 193300 used for long-distance phone cards in Shanghai area) and then receives a series of voice prompts. After each voice prompt, the user can input sequentially the type of language, the card number, the password and finally a called number. However, this approach suffers from the following drawbacks:

1) The user is required to input several pieces of information in several interactions in order to make a call, which is in convenience and time-consuming.

2) The user needs to check the card number and the password each time he or she is going to make a call.

3) The card number and the password are transmitted in a form of raw data over voice channels by a Dual-Tone Multi-Frequency (DTMF) signal, and thus they can be easily listened and stolen, especially in an IP network.

4) The service provider has to provide an Interactive Voice Response (IVR) device to play the voice prompts and gather card number information, which is expensive.

5) The number of user who can use the prepaid phone card service simultaneously is limited by the capacity of the IVR device.

### SUMMARY OF THE INVENTION

In view of the above defects in the prior art, it is an object of the present invention to provide a method and apparatus for establishing a session connection for a prepayment user in a terminal, and correspondingly, a method and apparatus for establishing a session connection for a prepayment user in a network server.

According to the first aspect of the present invention, a method for establishing a session connection for a prepayment user in a terminal is provided, which comprises steps of: sending to a network server a request message for establishing a session connection, wherein the request message contains characteristic information of supporting the prepayment function; receiving from the network server a reply message for requiring authentication information; sending an indication message for establishing the session connection to the network server, wherein the indication message contains all required authentication information of the prepayment user and a destination address.

According to the second aspect of the present invention, an apparatus for establishing a session connection for a prepayment user in a terminal is provided, which comprises: a first sending means for sending to a network server a request message for establishing a session connection, wherein the request message contains characteristic information of supporting the prepayment function; a first receiving means for receiving from the network server a reply message for requiring authentication information; a second sending means for sending to the network server an indication message for establishing the session connection, wherein the indication message contains all required authentication information of the prepayment user and a destination address.

According to the third aspect of the present invention, a method for establishing a session connection for a prepayment user in a network server is provided, which comprises steps of: receiving from a prepayment user terminal a request message for establishing a session connection; sending to the prepayment user terminal a reply message for requiring authentication information; receiving from the prepayment user terminal an indication message for establishing the session connection, wherein the indication message contains all required authentication information and a destination address; accomplishing the establishment of the session connection according to the received authentication information.

According to the fourth aspect of the present invention, an apparatus for establishing a session connection for a prepayment user in a network server is provided, which comprises: a first receiving means for receiving from a prepayment user terminal a request message for establishing a session connection; a first sending means for sending to the prepayment user terminal a reply message for requiring authentication information; a second receiving means for receiving from the prepayment user terminal an indication message for establishing the session connection, wherein the indication message contains all required authentication information and a destination address; a first connection establishing means for accomplishing the establishment of the session connection according to the received authentication information.

Compared with conventional prepayment services, the methods and apparatus according to the present invention have the following advantages:

1) The flow of user operation is simplified and the local interactive input device of the terminal, such as a liquid crystal display screen, is effectively utilized. In this way, the user just needs to input information in one interaction, which is time-saving.

2) The cost can be reduced for the service provider since the IVR device is not required to play voice prompts and collect DTMF signals.

3) The security can be improved since the card number and the password can be alphabets, instead of being limited to digits. Moreover, the password can be transmitted in an encrypted manner in a SIP message.

4) The capacity and performance of the system can be improved, since the IVR device which would become bottleneck of the system no longer exists.

### BRIEF DESCRIPTION OF THE DRAWINGS

The features, characteristics and advantages of the present invention will be more apparent from the following description with reference to the figures, in which:

FIG. 1 is a schematic diagram showing a process for establishing a session connection according to an embodiment of the present invention;

FIG. 2 is a flowchart showing a method for establishing a session connection for a prepayment user in a terminal according to an embodiment of the present invention;

FIG. 3 is a flowchart showing a method for establishing a session connection for a prepayment user in a network server according to an embodiment of the present invention;

FIG. 4 is a block diagram of a terminal for establishing a session connection for a prepayment user according to an embodiment of the present invention;

FIG. 5 is a block diagram of a network server for establishing session connection for a prepayment user according to an embodiment of the present invention; and

FIG. 6 is an input interface on a terminal according to an embodiment of the present invention.

### DETAILED DESCRIPTION OF THE PREFERRED EMBODIMENTS

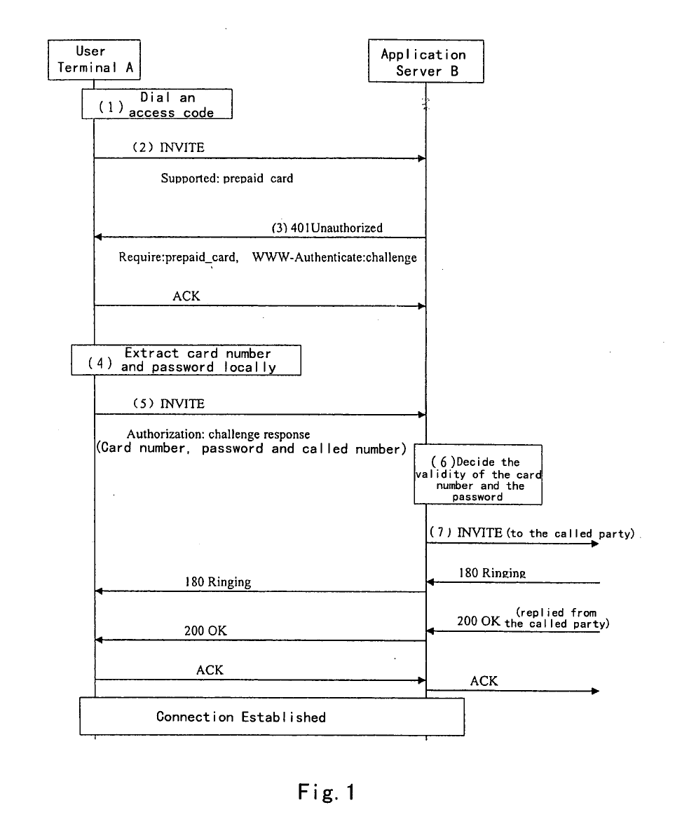

To address the above drawbacks in the prepayment service in the prior art, a new method for implementing a prepayment service in a NGN network is provided. FIG. 1 is a flowchart showing a process for establishing a session connection for a prepaid phone card service according to an embodiment of the present invention. Only a user terminal of prepaid phone card (a SIP terminal in this example) and an application server are shown for the purpose of briefness.

The process shown in FIG. 1 comprises the following steps.

1) The user of the prepaid phone card dials an access code (e.g., 193300).

2) The SIP terminal A of the prepaid phone card user sends to the application server B an INVITE message having a “Supported” field in its header indicating the support for the prepaid phone card service process.

3) Upon receipt of the INVITE massage from the terminal A, the application server B sends to the terminal A a 401 Unauthorized message for requiring authentication information for the prepaid phone card service (e.g., a card number and a password) and information on the called party.

4) The terminal A extracts the card number and the password of the prepaid phone card user and the information on the called party, which are pre-configured by the user, from a local storage device, and prompts the user to enter or modify them.

5) The terminal A sends to the application server B a new INVITE message containing the authentication information such as the card number and the password of the prepaid phone card user.

6) The application server B determines the validity of the received card number and password by querying a database of prepaid phone cards.

7) Upon determining that the card number and the password are valid, the application server B sends to the called party an INVITE message requesting to establish a connection.

The subsequent call procedures are the same as those in the prior art and the detailed description thereof is thus omitted herein.

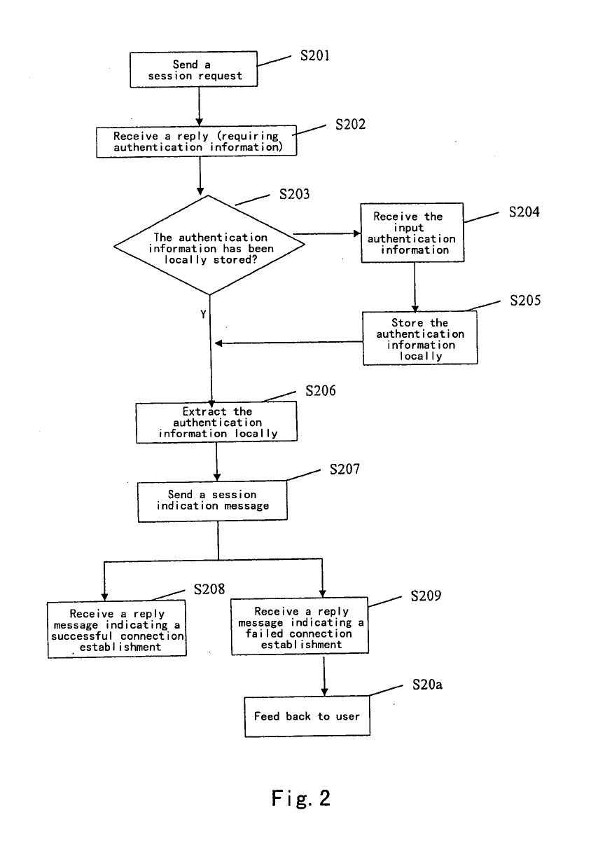

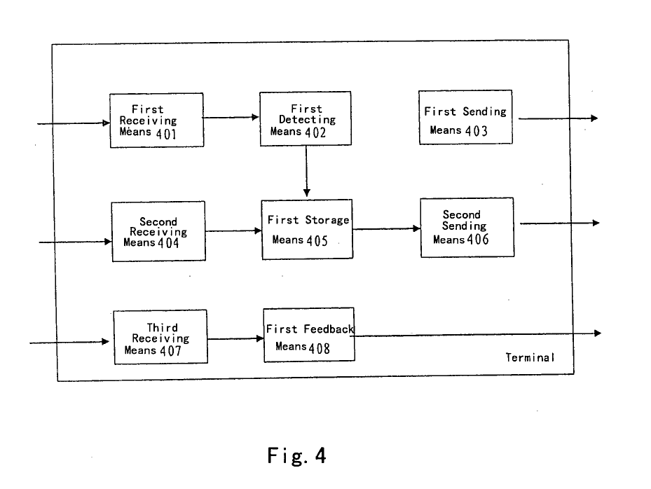

In the following, a method and apparatus for implementing the prepaid phone card service in a terminal will be detailed with reference to FIGS. 2 and 4.

After the user inputs a particular access code, the terminal A knows that the user is going to use the prepaid phone card service. Then, the terminal A triggers step S201 as shown in FIG. 2, in which a session request indicating the support for the prepaid phone card service is sent via a first sending means 403 as shown in FIG. 4 to the application server B. In order to indicate the feature of the prepaid phone card service in the SIP message, the SIP message is required to be extended and the corresponding SIP entities are required to support such function. Here are two examples. The first one, which is employed in the embodiment in FIG. 1, is shown in Table 1, in which the support for such service is indicated in the “Supported” field of the INVITE message. The second one is shown in Table 2, in which the support for such service is indicated in the “Supported” field of the OPTIONS message.

TABLE 1

INVITE sip:abc@lucent.com
Supported: prepaid_card
...
SIP/2.0 401 Unauthorized
Require: prepaid_card
WWW-Authentication:

TABLE 2

OPTIONS sip:abc@lucent.com
Supported: prepaid_card
...
SIP/2.0 200 OK
Supported: prepaid_card

Next, the terminal A receives, via a first receiving means 401, from the application server B a reply message (e.g., 401 Unauthorized or 200 OK) for requiring authentication information, as shown at step S202 in FIG. 2. The terminal A detects, by using a first detecting means 402, whether the authentication information of the user, such as the card number and the password, has been stored in a first local storage means 405.

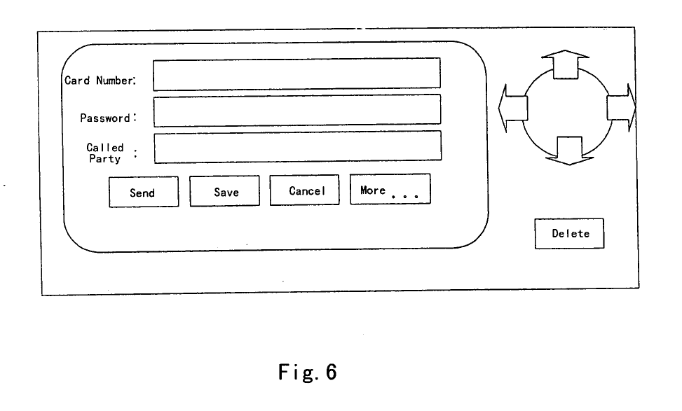

If the first detecting means 402 detects that the card number and the password of the user have not been locally stored, which is typically the case when the user uses this prepaid phone card service for the first time, the terminal A will prompt the user to input the card number, the password and the called number, for example by popping up an input interface as shown in FIG. 6. After completion of the user input, the terminal A receives via a second receiving means the card number, the password and the called number inputted by the user, as shown at step S204. Next, the card number and the password are locally stored in the first storage means 405 for future use, as shown at step S205. Then the process proceeds with step S206.

If the first detecting means 402 detects that the card number and the password have been locally stored, the user will be prompted to input only the called number. Again, the process then proceeds with step S206 in which the first storage means 405 extracts the card number and the password, and sends them to a second sending means 406 along with the called number. The second sending means 406 performs step S207 to send to the application server B a session indication message (an INVITE message in this example) indicating the card number, the password and the called number. Herein, the password can be encrypted and then transmitted in a ciphertext form. The encryption process has been well defined in SIP, and the description thereof is thus omitted herein. The above information can be placed in the “Authorization” header of the INVITE message with the value of “response” indicating the encrypted authentication information, as shown in Table 3.

TABLE 3

INVITE sip:abc@lucent.com
Authorization: Digest realm= “PPAS”,
card_id= “24036493203543535”,
destination= “02180550551”, response= “4e4c8e53088
de62e109a82dee4ad2a01”,
nonce= “1023109332501”, algorithm=MD5

After step S207, the terminal A waits for a reply from the application server B. There are two possible situations. In one situation, the terminal A receives via a third receiving means 407 a reply message indicating a successful connection as shown at step S208. The connection has been established at this time, and the subsequent steps are the same as those in the existing SIP process. In the other situation, the terminal A receives via the third receiving means 407 a reply message indicating a failed connection, as shown at step S209. In this case, the terminal A will display a corresponding one of various error messages, such as “Sorry. Insufficient Balance!”, “Incorrect Password!” or “Please use a new card!”, to the user via a first feedback means 408 according to the content of the reply message.

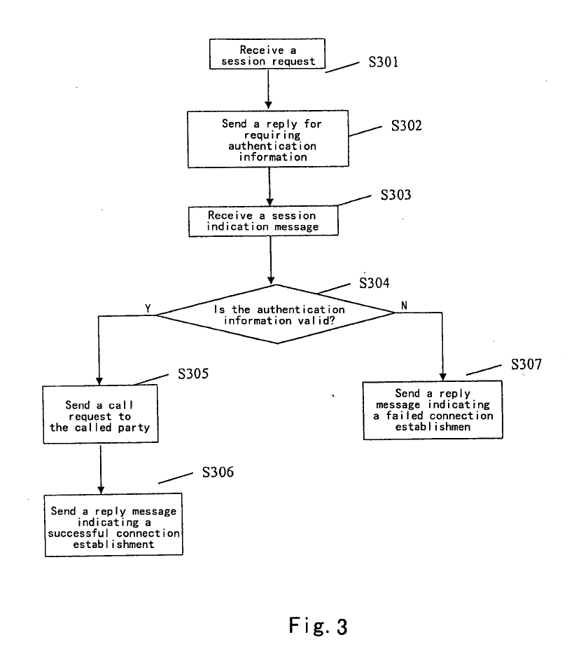

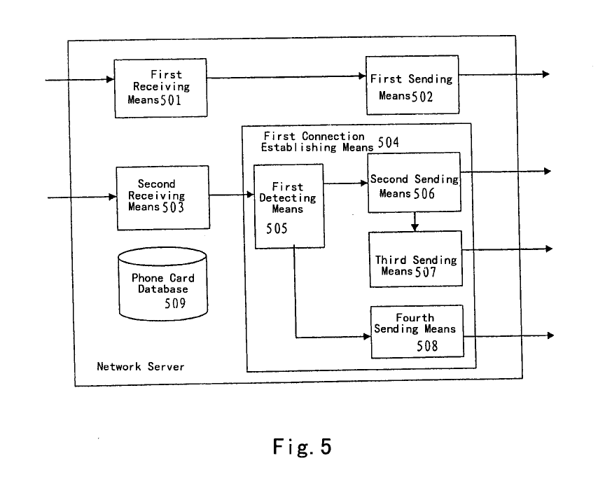

Accordingly, a method and apparatus for establishing a connection for a prepaid phone card user in the application server B will be described in detail with reference to FIGS. 3 and 5, respectively.

At step S301, the application server B receives a session request message from the terminal A via a first receiving means 501, and recognizes it as a request for a prepaid phone card service. As authentication information is necessary for accessing this service, the application server B sends, via a first sending means 502, to the terminal A a reply message for requiring authentication information, as shown at step S302. There can be a variety of the reply messages, depending on the type of the received session request message. For example, if the session request message is an INVITE message as shown in Table 1, then the reply message can be a 401_Unauthorized message as shown in Table 1; and if the session request message is an OPTIONS message as shown in Table 2, then the reply message can be a 200_OK message as shown in Table 2.

After step S302, the application server B proceeds with step S303 where it receives, via a second receiving means 503, from the terminal A a session indication message (an INVITE message in this example) containing all authentication information of the user (e.g., the card number and the password) and the called number. Then, the application server B accomplishes the establishment of the connection according to the received authentication information by using a first connection establishing means 504.

In particular, at step S304, a first decision means 505 in the first connection establishing means 504 decides the validity of the received authentication information by querying a local database of prepaid phone cards 509. If the password is encrypted, the application server B can decrypt it using' some existing technology. Herein, the decision of validity comprises decision of correctness of the card number and the password, decision of balance and the like.

If the decision at step S304 indicates that the authentication information is valid, a second sending means 506 in the first connection establishing means 504 can send a session request to the called party, as shown at step S305. Upon receipt of acknowledgement from the called party, a third sending means 507 in the first connection establishing means 504 sends to the calling party, i.e., the prepaid phone card terminal A, a reply message indicating a successful connection establishment, as shown at step S306.

If the decision at step S304 indicates that the authentication information is invalid, a fourth sending means 508 in the first connection establishing means 504 sends to the calling party, i.e., the prepaid phone card terminal A, a reply message indicating a failed connection establishment as well as cause of the failure, as shown at step S307.

While some embodiments of the present invention have been provided in the above description, they are not intended to limit the scope of the present invention. Various modifications and changes can be made to these embodiment by those who skilled in the art, without departing from the scope and spirit of the present invention. Such modifications and changes fall into the scope of the present invention.

What is claimed is:

1. A method for establishing a session connection for a prepayment user in a terminal, the method comprising steps of:
a) sending to a network server a request message for establishing a session connection, wherein the request message contains characteristic information of supporting the prepayment function;
b) receiving from the network server a reply message for requiring authentication information;
f) sending an indication message for establishing the session connection to the network server, wherein the indication message contains all required authentication information of the prepayment user and a destination address.

2. The method of claim 1, wherein, before the step f), the method further comprises steps of:
c) detecting whether there is authentication information of the prepayment user in a local storage device;
e) extracting all required authentication information of the prepayment user from the local storage device.

3. The method of claim 2, wherein, before the step e), the method further comprising steps of:
if it is detected that there is no authentication information of the prepayment user in the local storage device at the step c), then
d1) receiving authentication information inputted by the user;
d2) storing the received authentication information in the local storage device.

4. The method of one of claim 1, wherein further comprising steps of:
g1) receiving from the network server a reply message indicating whether the connection establishment is successful or failed;
g2) feeding different content back to the user according to different error prompt information, if the connection establishment is failed.

5. A method for establishing a session connection for a prepayment user in a network server, the method comprising steps of:
A) receiving from a prepayment user terminal a request message for establishing a session connection;
B) sending to the prepayment user terminal a reply message for requiring authentication information;
C) receiving from the prepayment user terminal an indication message for establishing the session connection, wherein the indication message contains all required authentication information and a destination address;
D) accomplishing the establishment of the session connection according to the received authentication information.

6. The method of claim 5, wherein the step D) further comprises step of:
D1) querying a local database, and deciding the validity of the received authentication information.

7. The method of claim 5, wherein the step D) further comprises step of:
D21) sending a session request message to a called party according to the received destination address so as to establish a session connection, if the received authentication information is valid;
D22) sending to the prepayment user terminal a reply message indicating that the establishment of the session connection is successful.

8. The method of claim 5, wherein the step D) further comprises step of:
D3) sending to the prepayment user terminal a reply message indicating that the establishment of the session connection establishing is failed, if the received authentication information is invalid.

9. An apparatus for establishing a session connection for a prepayment user in a terminal, the apparatus comprising:
a first sending means for sending to a network server a request message for establishing a session connection, wherein the request message contains characteristic information of supporting the prepayment function;
a first receiving means for receiving from the network server a reply message for requiring authentication information;
a second sending means for sending to the network server an indication message for establishing the session connection, wherein the indication message contains all required authentication information of the prepayment user and a destination address.

10. The apparatus of claim 9, wherein further comprising:
a first detecting means for detecting whether there is authentication information of the prepayment user in a first storage device;
a first storage means for extracting authentication information of the prepayment user stored in the first storage device.

11. The apparatus of claim 9, wherein further comprising:
a second receiving means for receiving authentication information of the prepayment inputted by the user;
wherein the first storage means is further adapted for storing the received authentication information.

12. The apparatus of one of claim 9, wherein further comprising:
a third receiving means for receiving from the network server a reply message indicating whether the connection establishment is successful or failed;
a first feedback means for feeding different content back to the user according to different error prompt information, if the connection establishment is failed.

13. An apparatus for establishing a session connection for a prepayment user in a network server, the apparatus comprising:
a first receiving means for receiving from a prepayment user terminal a request message for establishing a session connection;
a first sending means for sending to the prepayment user terminal a reply message for requiring authentication information;
a second receiving means for receiving from the prepayment user terminal an indication message for establishing the session connection, wherein the indication message contains all required authentication information and a destination address;
a first connection establishing means for accomplishing the establishment of the session connection according to the received authentication information.

14. The apparatus of claim 13, wherein the first connection establishing means further comprises:
a first decision means for querying a local database and deciding the validity of the received authentication information.

15. The apparatus of claim 13, wherein the first connection establishing means further comprises:
a second sending means for sending a session request message to a called party according to the received destination address, if the first decision means decides that the received authentication information is valid;
a third sending means for sending to the prepayment user terminal a reply message indicating that the establishment of the session connection is successful.

16. The apparatus of claim 13, wherein the first connection establishing means further comprises:
D3) a fourth sending means for sending to the prepayment user terminal a reply message indicating that the establishment of the session connection establishing is failed, if the received authentication information is invalid.
